(19) United States
(12) Patent Application Publication
(10) Pub. No.: US 2006/0092305 A1
(43) Pub. Date: May 4, 2006

(54) Solid-state image pickup device and driving method therefor

(75) Inventors: Ichiro Baba, Nara (JP); Takashi Yamada, Kyoto (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/264,513

(22) Filed: Oct. 31, 2005

(30) Foreign Application Priority Data
Nov. 1, 2004 (JP) P2004-317936

(51) Int. Cl. H04N 5/335; H04N 3/14

(52) U.S. Cl. 348/311

(57) ABSTRACT

The solid-state image pickup device comprises: light-receiving pixels which convert incident light into charges; a vertical-transfer section which has a plurality of transfer gates for transferring charges read from the light-receiving pixels in the column direction; a horizontal-transfer section which is coupled with the vertical-transfer section and outputs charges transferred from the vertical-transfer section in a horizontal period cycle; a timing pulse producing section which produces timing pulses for producing driving signals for driving the transfer gates; and a driving signal producing section for producing driving signals for driving the transfer gates based on outputs from the timing pulse producing section. The timing pulse producing section produces the timing pulses in such a manner that distributions of timing pulse switching periods of driving signals for driving at least two of the transfer gates in the same column have the same distribution ratio, to each other, as the distribution of reference switching periods obtained from frequency dependence of charge transfer efficiencies such that the charge transfer efficiencies of the transfer gates are not less than a predetermined value.

### CROSS-REFERENCE TO RELATED APPLICATIONS

The present non-provisional application claims priority based on JP 2004-317936 applied for patent in Japan on Nov. 1, 2004 under U.S. Code, Volume 35, Chapter 119(a). The disclosure of the application is fully incorporated herein by reference.

### BACKGROUND OF THE INVENTION

The present invention relates to a solid-state image pickup device, in particular to a solid-state image pickup device driven in a plurality of driving modes and a driving method of the same.

Conventionally, in a solid-state image pickup device, charges produced by light-receiving pixels are transferred in the vertical direction by a vertical-transfer charge coupled device (VCCD) connected to the light-receiving pixels. FIG. 11 is a timing chart showing driving signals applied to electrodes φV1 to φV4 contained in one system of transfer gates constituting the VCCD. The VCCD in which the driving signals in the timing chart are applied to the transfer gates carries out charge transfer as shown in FIG. 12. FIG. 13 shows frequency dependence of efficiencies of charge transfer carried out by the VCCD in this case. As shown in FIG. 13, the characteristic of the VCCD deteriorates as the device is driven at a higher rate, causing a decrease in capacity of the VCCD, an increase in amount of charges left out, etc. In addition, the characteristic of the VCCD is restricted by a transfer gate having the lowest frequency dependence among the above transfer gates. That is, when the characteristic of one transfer gate of the VCCD deteriorates, even if sufficient charge transfer is carried out by other transfer gates of the VCCD, the characteristic of the VCCD as a whole deteriorates due to the transfer gate the characteristic of which has deteriorated. This is a very big problem in driving the solid-state image pickup device at a high rate.

A first conventional technology proposed to solve such a problem is a method of unevenly distributing timing pulse switching periods for producing driving signals for a VCCD (see Japanese Laid-open Patent Publication No. HEI-11-355663 A1). In the first conventional technology, periods in which the number of gates to which high pulses are applied is a minimum are set to be longer than other periods. That is, when the number of transfer gate electrodes to which high pulses are simultaneously applied varies in sequence like, for example, two-three-two-three, timing pulse switching periods in which the number of electrodes to which high pulses are applied is two are designed to be longer than other switching periods.

In addition, a second conventional technology proposed to solve the above problem is a technology wherein the length of a control interval starting at a point where a predetermined driving voltage is applied to a transfer gate electrode having the largest time constant is made longer than the lengths of other control intervals (see Japanese Laid-open Patent publication No. 2002-262183 A1). That is, in the plurality of transfer gates of a VCCD, upon application of a driving signal, the longer wave form rise time of the driving signal a transfer gate exhibits due to its RC time constant, the longer timing pulse switching period is set for the transfer gate.

However, parameters for deciding an actual charge transfer efficiency of a VCCD are complicated because many factors such as τi: input wave form rise up time constant (time constant related to the ability of the input driver), τC (R, C): gate RC circuit time constant (R: gate wiring resistance, C: gate additional capacitance), τS (N, D): self-diffusion time constant (N: electron number, D: diffusion coefficient), and τd (L, V): fringe electric field drift time constant (L: gate length, V: gate applied voltage) are associated with the parameters. We therefore have a problem that it is hard to effectively improve the charge transfer efficiency of a VCCD by the first and second technologies.

Furthermore, it is usual to drive one VCCD in a plurality of modes such as, for example, a still driving mode, a monitor driving mode, a sweep-out driving mode, a dynamic picture addition driving mode, and a cut-out shift driving mode. Furthermore, there is a case that directional electric fields for charge transfer are provided in relation to potentials beneath transfer gates of a VCCD. Like this, when a VCCD is driven in a plurality of modes or when potentials beneath transfer gates vary with the transfer gates, the charge transfer efficiency may deteriorate under a predetermined condition, and switching periods of driving signals for a predetermined VCCD may become longer.

FIG. 14 schematically shows a VCCD in which potentials are made evenly beneath the transfer gates, and FIG. 15 schematically shows a VCCD in which directional electric fields for charge transfer are provided in relation to potentials beneath the transfer gates. In the VCCD in FIG. 15, potential difference regions 101 and 102 of transfer channels are made beneath the electrodes φV2′ and φV4′ by impurity injection or the like. In the VCCD in FIG. 14, the additional capacitances and wiring resistances of the gate electrodes φV1 to φV4 are equivalent to each other, and therefore the waveform distortions of driving signals (pulses) applied to the gate electrodes are equivalent to each other. Also in the VCCD in FIG. 15, the additional capacitances and wiring resistances of the gate electrodes φV1′ to φV4′ are equivalent to each other, and therefore the waveform distortions of driving signals (pulses) applied to the gate electrodes are equivalent to each other.

When the second conventional technology is applied to the VCCD in FIG. 14, that is, when the driving signals are controlled in such a manner that “the length of a control interval starting at a point where a predetermined driving voltage is applied to a transfer gate electrode having the largest time constant is made longer than the lengths of other control intervals”, since the electrodes φV1 to φV4 have approximately equal RC time constants, the period distributions of driving pulses to be applied to the electrodes φV1 to φV4 are also approximately equal to each other, and therefore an optimum device operation can be realized.

However, the second conventional technology can not be applied to the VCCD in FIG. 15. Because, in the VCCD in FIG. 15, the RC time constants of the gate electrodes themselves are approximately equal, but all of the potential structures of transfer channels beneath the gate electrodes are not equal. That is, the transfer channels beneath the gate electrodes φV1′ and φV3′ have flat potential structures like the transfer channels beneath the gate electrodes φV1 and φV3 in FIG. 14, but the transfer channels beneath the gate electrodes φV2′ and φV4′ are provided with the potential difference regions 101 and 102 described above. Because of this, charge transfer rates in the transfer channels beneath the gate electrodes φV2′ and φV4′ are higher than charge transfer rates in the transfer channels beneath the gate electrodes φV1′ and φV3′. For this reason, when driving pulses having switching periods equal to each other are applied, based on the second conventional technology, to the electrodes φV1′ to φV4′ of the VCCD having the structure in FIG. 15, transfer time is wasted at the electrodes φV2′ and φV4′.

Like this, there are many factors having an influence on the charge transfer efficiency of a VCCD, such as, for example, the input rise up time constants, self-diffusion time constants, and fringe electric field drift time constants, other than the RC time constants of the gate electrodes, and therefore a sufficient charge transfer efficiency can not be obtained by the second conventional technology. In addition, when the RC time constants of the gate electrodes are equal to each other, but the potential structures of the transfer channels beneath the gate electrodes are different from each other, a sufficient charge transfer efficiency can not be obtained.

### SUMMARY OF THE INVENTION

It is therefore an object of the present invention to provide a solid-state image pickup device which has a good charge-transfer efficiency with stability even if there is a difference of charge transfer characteristic among the plurality of transfer gates.

In order to achieve the above object, there is provided a solid-state image pickup device comprising:

light-receiving pixels which are disposed in the form of a matrix and convert incident light into charges;

a vertical-transfer section which has a plurality of transfer gates for transferring charges read from the light-receiving pixels in the column direction and which transfer charges read from the light-receiving pixels in the vertical direction;

a horizontal-transfer section which is coupled with the vertical-transfer section and outputs charges transferred from the vertical-transfer section in a horizontal period cycle;

a timing pulse producing section which produces timing pulses for producing driving signals for driving the transfer gates, the timing pulse producing section producing the timing pulses in such a manner that distributions of timing pulse switching periods of driving signals for driving at least two of the transfer gates in the same column have the same distribution ratio, to each other, as the distribution of reference switching periods obtained from frequency dependence of charge transfer efficiencies such that the charge transfer efficiencies of the transfer gates are not less than a predetermined value; and

a driving signal producing section for producing driving signals for driving the transfer gates based on outputs from the timing pulse producing section.

According to the above configuration, with respect to the distribution of timing pulse switching periods, each of the switching periods is set to such a switching period that the charge transfer efficiencies of the transfer gates are not less than a predetermined value, based on the frequency dependence of charge transfer efficiencies which reflects the influence of, for example, the input wave rise up time constants, self-diffusion time constants, fringe electric field drift time constants, etc. Timing pulses distributed at the same distribution ratio as the distribution of reference switching periods including the switching periods set as above are produced by the timing pulse producing section. Based on the above timing pulses, driving signals are produced by the driving signal producing section. Since the transfer gates are driven by these driving signals, even if there is a difference of characteristic among the plurality of transfer gates, the charge transfer efficiency of the vertical-transfer section can be effectively improved.

In this connection, the frequency dependence of charge transfer efficiencies refers to a change in charge transfer efficiencies of the transfer gates which occurs when changing the switching periods for which the frequency dependence should be obtained while other switching periods are made equal to each other not to be changed. Furthermore, in relation to the distribution of timing pulse switching periods obtained from the frequency dependence of charge transfer efficiencies, the “predetermined value” of charge transfer efficiency is preferably 70%, more preferably 80%, or further more preferably 90%.

In one embodiment of the present invention, the timing pulse producing section produces timing pulses in such a manner that when n (natural number of 4 or more) timing pulse switching periods for producing driving signals for driving the transfer gates in a first mode are t1¹, t2¹₁ t3¹, . . . , and tn¹, n timing pulse switching periods for producing driving signals for driving the transfer gates in a second mode are t1², t2², t3², . . . , and tn², and n reference switching periods are T1, T2, T3, . . . , and Tn, the first mode switching periods t1¹, t2¹, t3¹, . . . , tn¹, the second mode switching periods t1², t2², t3², . . . , tn², and the reference switching periods T1, T2, T3, . . . , Tn satisfy the relation of t1¹:t2¹:t3¹: . . . :tn¹=t1²:T2²:t3²: . . . :tn²=T1:T2:T3: . . . :Tn.

According to the embodiment, the first mode driving signals and the second mode driving signals can be produced based on the frequency dependence of charge transfer efficiencies, so that the efficiency of charge transfer carried out by the vertical-transfer section can be effectively improved in either of the first and second modes.

In one embodiment of the present invention, the timing pulse producing section divides n (natural number of 4 or more) timing pulse switching periods for producing driving signals for driving the transfer gates into m (natural number of 2 or more) groups less than the n switching periods, and produces timing pulses in such a manner that when timing pulse switching periods belonging to the m groups are t(G1), . . . , and t(Gm), and reference switching periods corresponding to the m groups are T(G1), and T(Gm), the switching periods t(G1), . . . , t(Gm) and the reference switching periods T(G1), . . . , T(Gm) satisfy the relation of t(G1): . . . :T(Gm)=T(G1): . . . :T(Gm).

According to the embodiment, switching periods are decided for each of groups of timing pulses by the timing pulse producing section, and driving signals are produced for each of the groups of timing pulses by the driving signal producing section. Thus, the number of registers, for example, of the pulse producing section can be made less than a number required when switching periods are decided for all timing pulses, so that the configuration of the timing pulse producing section can be simplified.

In one embodiment of the present invention, the timing pulse producing section divides n (natural number of 4 or more) timing pulse switching periods for producing driving signals for driving the transfer gates into m (natural number of 2 or more) groups less than the number of the switching periods, and produces timing pulses in such a manner that when timing pulse switching periods belonging to the m groups for producing driving signals for driving the transfer gates in a first mode are t(G1)¹, . . . , and t(Gm)¹, timing pulse switching periods belonging to the m groups for producing driving signals for driving the transfer gates in a second mode are t(G1) ², . . . , and t(Gm) ², and reference switching periods corresponding to the m groups are T(G1), . . . , and T(Gm), the first mode switching periods t(G1)¹, . . . , t(Gm)¹, the second mode switching periods t(G1)², . . . , t(Gm)², and the reference switching periods T(G1), . . . , T(Gm) satisfy the relation of t(G1)¹: . . . :T(Gm)¹=t(G1)²: . . . :t(Gm)²=T(G1): . . . :T(Gm).

According to the embodiment, the first mode driving signals and the second mode driving signals are produced based on the frequency dependence of charge transfer efficiencies, and timing pulse switching periods for the driving signals are decided for each of the groups described above. Thus, the charge transfer efficiency of the vertical-transfer section can be effectively improved in either of the first and second modes, and the configuration of the timing pulse producing section can be simplified.

In one embodiment of the present invention, the timing pulse producing section includes a storage section in which information about the switching periods t1¹, t2¹, t3¹, . . . , tn¹ of driving signals for driving the transfer gates in the first mode, the switching periods tl2, t2², t3², tn² of driving signals for driving the transfer gates in the second mode, and the reference switching periods T1, T2, T3, . . . , Tn has been previously stored.

According to the embodiment, the timing pulse producing section is able to produce timing pulses easily and speedily using information about the timing pulse switching periods previously stored in the storage section.

In one embodiment of the present invention, the timing pulse producing section includes a storage section in which information about the switching periods t(G1)¹, . . . , t(Gm)¹ of driving signals for driving the transfer gates in the first mode, and the switching periods t(G1)², . . . , t(Gm)² of driving signals for driving the transfer gates in the second mode, which are timing pulse switching periods belonging to the m groups, and information about the reference switching periods T(G1), . . . , T(Gm) have been previously stored.

According to the embodiment, the timing pulse producing section is able to produce timing pulses easily and speedily using information about the timing pulse switching periods previously stored in the storage section.

Also, there is provided a driving method of a solid-state image pickup device comprising:

light-receiving pixels which are disposed in the form of a matrix and convert incident light into charges;

a vertical-transfer section which has a plurality of transfer gates for transferring charges read from the light-receiving pixels in the column direction and which transfer charges read from the light-receiving pixels in the vertical direction; and

a horizontal-transfer section which is coupled with the vertical-transfer section and outputs charges transferred from the vertical-transfer section in a horizontal period cycle, wherein

timing pulses for producing driving signals for driving the transfer gates are produced in such a manner that distributions of timing pulse switching periods of driving signals for driving at least two of the transfer gates in the same column have the same distribution ratio, to each other, as the distribution of reference switching periods obtained from frequency dependence of charge transfer efficiencies such that the charge transfer efficiencies of the transfer gates are not less than a predetermined value, and

driving signals for driving the transfer gates are produced based on the timing pulses.

According to the above configuration, with respect to the distribution of timing pulse switching periods, each of the switching periods is set to such a switching period that the charge transfer efficiencies of the transfer gates are not less than a predetermined value based on the frequency dependence of charge transfer efficiencies which reflects the influence of, for example, the input wave rise up time constants, self-diffusion time constants, fringe electric field drift time constants, etc. Timing pulses distributed at the same distribution ratio as the distribution of reference switching periods including the switching periods set as above are produced. Driving signals are produced based on the above timing pulses, and the transfer gates are driven by the driving signals, so that even if there is a difference of characteristic among the plurality of transfer gates, the charge transfer efficiency of the vertical-transfer section can be effectively improved.

In this connection, the frequency dependence of charge transfer efficiencies refers to a change in charge transfer efficiencies of the transfer gates which occurs when changing the switching periods for which the frequency dependence should be obtained while other switching periods are made equal to each other not to be changed. Furthermore, in relation to the distribution of timing pulse switching periods obtained from the frequency dependence of charge transfer efficiencies, the “predetermined value” of charge transfer efficiency is preferably 70%, more preferably 80%, or further more preferably 90%.

In one embodiment of the present invention, n (natural number of 4 or more) timing pulse switching periods for producing driving signals for driving the transfer gates are divided into m (natural number of 2 or more) groups less than the number of the switching periods, and timing pulses are produced in such a manner that when timing pulse switching periods belonging to the m groups for producing driving signals for driving the transfer gates in a first mode are t(G1)¹, . . . , and t(Gm)¹, timing pulse switching periods belonging to the m groups for producing driving signals for driving the transfer gates in a second mode are t(G1)², . . . , and t(Gm)², and reference switching periods corresponding to the m groups are T(G1), . . . , and T(Gm), the first mode switching periods t(G1)¹, . . . , t(Gm)¹, the second mode switching periods t(G1)², . . . , t(Gm)², and the reference switching periods T(G1), T(Gm) satisfy the relation of t(G1)¹: . . . :t(Gm)¹=t(G1)²: . . . :T(Gm)²=T(G1): . . . :T(Gm).

According to the embodiment, the first mode driving signals and the second mode driving signals can be produced based on the frequency dependence of charge transfer efficiencies, and timing pulse switching periods for the driving signals can be decided for each of the groups described above. Thus, the charge transfer efficiency of the vertical-transfer section can be effectively improved in either of the first and second modes, and timing pulses can be produced with a simple circuit configuration.

As described above, the solid-state image pickup device comprises: light-receiving pixels which are disposed in the form of a matrix and convert incident light into charges; a vertical-transfer section which has a plurality of transfer gates for transferring charges read from the light-receiving pixels in the column direction and which transfer charges read from the light-receiving pixels in the vertical direction; a horizontal-transfer section which is coupled with the vertical-transfer section and outputs charges transferred from the vertical-transfer section in a horizontal period cycle; a timing pulse producing section which produces timing pulses for producing driving signals for driving the transfer gates, the timing pulse producing section producing the timing pulses in such a manner that distributions of timing pulse switching periods of driving signals for driving at least two of the transfer gates in the same column have the same distribution ratio, to each other, as the distribution of reference switching periods obtained from frequency dependence of charge transfer efficiencies such that the charge transfer efficiencies of the transfer gates are not less than a predetermined value; and a driving signal producing section for producing driving signals for driving the transfer gates based on outputs from the timing pulse producing section. Therefore, even if there is a difference of characteristic among the plurality of transfer gates, the charge transfer efficiency of the vertical-transfer section can be effectively improved.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows frequency dependence of charge transfer efficiencies with respect to pulse switching periods t1 to tn of driving signals.

FIG. 2 is a schematic diagram showing the solid-state image pickup device of the first embodiment of the present invention.

FIG. 3 is a schematic diagram showing the control section of the solid-state image pickup device of the first embodiment.

FIG. 4 shows driving signals in the first driving mode of a VCCD.

FIG. 5 shows driving signals in the second driving mode of a VCCD.

FIG. 6 shows driving signals in the third driving mode of a VCCD.

FIG. 7 is a schematic diagram showing a variation of the control section.

FIG. 8 is a schematic diagram showing the control section of the solid-state image pickup device of the second embodiment.

FIG. 9 shows driving signals for the VCCD in the second embodiment.

FIG. 10 is a schematic diagram showing a variation of the control section.

FIG. 11 shows driving signals applied to the electrodes of the transfer gates of a VCCD.

FIG. 12 shows charge transfer by a VCCD.

FIG. 13 shows frequency dependence of charge transfer efficiencies of a VCCD.

FIG. 14 is a schematic diagram showing a VCCD in which potentials are made evenly beneath the transfer gates.

FIG. 15 is a schematic diagram showing a VCCD in which directional electric fields for charge transfer are provided beneath the transfer gates.

### DETAILED DESCRIPTION OF THE INVENTION

At first, in advance of a description of embodiments of the present invention, frequency dependence of charge transfer efficiencies will be described in relation to the transfer gates provided in a vertical-transfer charge coupled device (referred to as VCCD hereinafter) which is the vertical-transfer section of a solid-state image pickup device.

Charge transfer time ta required for one driving cycle of the VCCD and the number of driving phases Np of the VCCD can be represented as
ta=t1+t2+t3+ . . . +tn (1)
Np=n/2 (2)
where n is the number of pulse switches of driving signals for the VCCD, and t1 to tn are timing pulse switching periods.

The charge transfer efficiency of the VCCD in this condition can be represented by
(1−f)/1 (3)
where f (t1, t2, t3, . . . , tn) is the amount of charges left out. Here exists frequency dependence of charge transfer efficiencies in relation to each of the switching periods t1 to tn.

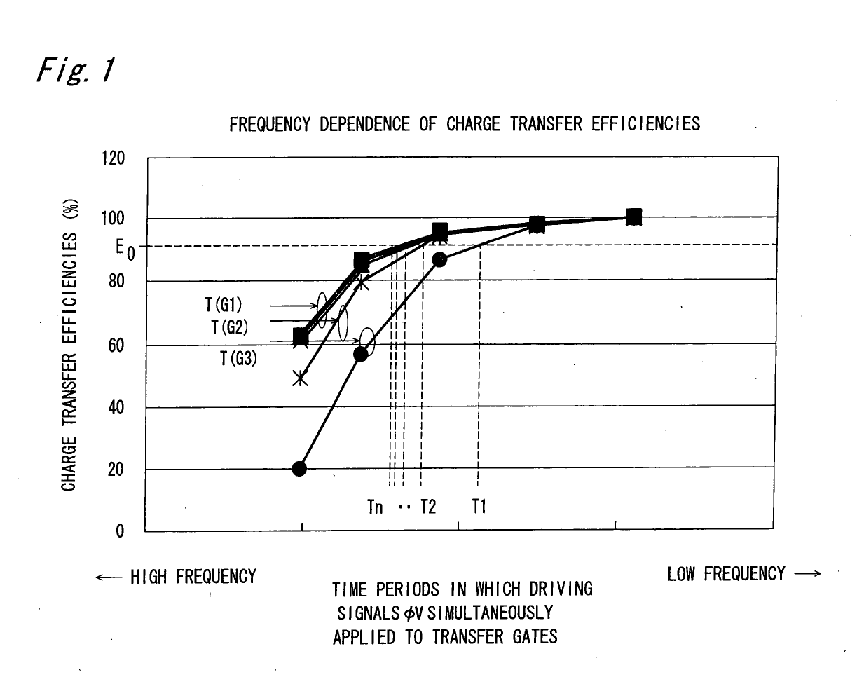

FIG. 1 is a graph showing frequency dependence of charge transfer efficiencies with respect to timing pulse switching periods t1 to tn for the driving signals. The frequency dependence of charge transfer efficiencies is obtained as follows when explained by taking the switching period t1 as an example. That is, a change in charge transfer efficiencies of the transfer gates is measured under a condition that the switching period t1 is made small (the frequency is made large) while other switching periods t2 to tn are made equal to each other and kept unchanged. By representing the measured values of the charge transfer efficiencies of the transfer gates in graphical form with a correspondence with the magnitude of the switching period t1 (frequency), the frequency dependence of charge transfer efficiencies for the switching period t1 is obtained. Also for t2 to tn, similar graphical representations of the measured value are performed and graphs like FIG. 1 are obtained as a result.

As shown in FIG. 1, regarding each switching periods t1 to tn, charge transfer efficiencies decrease as time periods in which driving signals are simultaneously applied to transfer gates (gate electrodes) decrease. In FIG. 1, the horizontal axis represents the lengths of switching period, that is, the lengths of time periods in which driving signals are simultaneously applied to a plurality of gate electrodes (φV). The lengths of switching periods correspond to the frequencies of timing switching periods. By using a characteristic diagram like FIG. 1, shortest periods T1 to Tn providing a predetermined charge transfer efficiency (90% represented by E₀ on the vertical axis in FIG. 1) are obtained with respect to the switching periods t1 to tn. Using the periods T1 to Tn (referred to as optimum switching periods), the charge transfer time Ta of one cycle of the VCCD can be represented as
Ta=T1+T2+T3+ . . . +Tn (4)
Ta is an optimum charge transfer time obtained from the predetermined charge transfer efficiency.

An optimum switching period Tn can be represented as Tn (τin, τcn, τsn, τdn), where τin, τcn, τsn, and τdn are parameters. Tin is an input wave form rise up time constant which is a time constant related to the ability of the input driver. τcn is a transfer gate RC circuit time constant which is a constant obtained from a wiring resistance R and an additional capacitance C. τsn (Ne, D) is a self-diffusion time constant which is a constant obtained from an electron number Ne and a diffusion coefficient D. τdn is a fringe electric field drift time constant which is a constant obtained from a gate length L and a gate applied voltage V.

The present invention improves the charge transfer efficiency of a VCCD based on such relations, and in particular effectively improves the charge transfer efficiency of a VCCD when driving the VCCD in a plurality of driving modes such as, for example, a still driving mode, a monitor driving mode, a sweep-out driving mode, a dynamic picture pixel addition driving mode, and a cut-out shift driving mode, in a solid-state image pickup device used for a digital still camera, movie equipment, or the like.

### FIRST EMBODIMENT

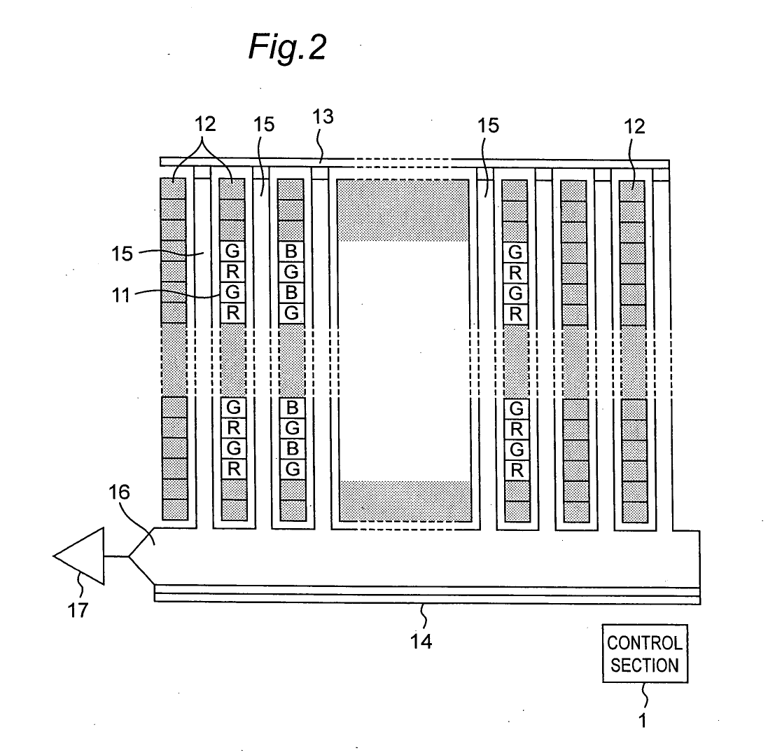

FIG. 2 is a schematic diagram showing the solid-state image pickup device of the first embodiment of the present invention. The solid-state image pickup device comprises photodiodes 11 which are disposed as light-receiving pixels in the form of a matrix and convert incident light into signal charges, a VCCD 15 which reads signal charges stored in the photodiodes 11 and transfers them in the column direction (vertical direction) as a vertical-transfer section, a HCCD 16 which transfers signal charges from the VCCD 15 in the row direction (horizontal direction) as a horizontal-transfer section, and an output amplifier 17 for amplifying signal charges transferred from the HCCD 16 to output them. The VCCD 15 is provided with a plurality of transfer gates for transferring charges read from the photodiodes 11 in the column direction. Red (R), green (G), and blue (B) color filters are arranged on the photodiodes 11. Furthermore, optical black level regions 12 for generating reference levels of image signals, and a vertical surplus charge sweep-out drain 13 and horizontal surplus charge sweep-out drain 14 for sweeping out surplus charges are provided. In addition, a control section 1 is provided for performing the control of the whole device including transfer timing control.

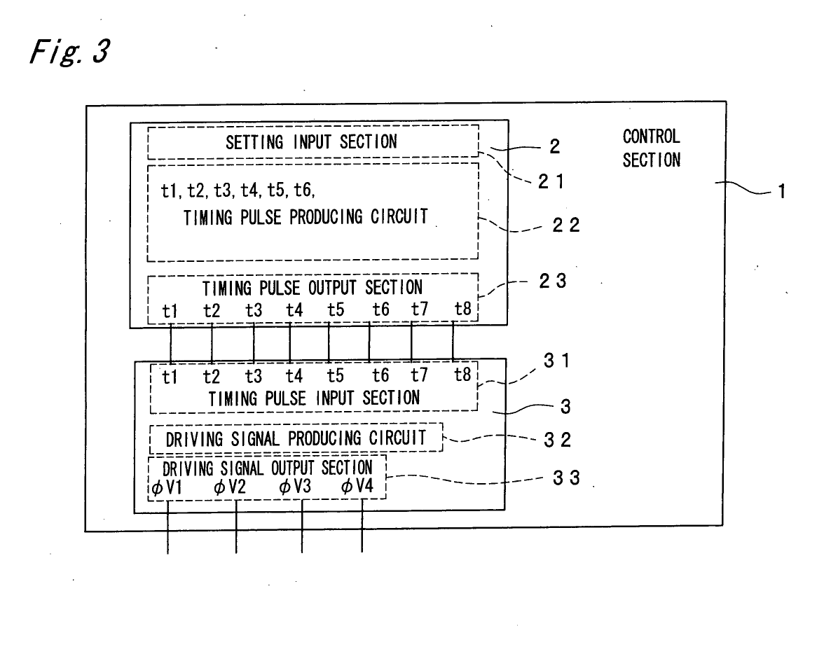

FIG. 3 is a schematic diagram showing the control section 1. The control section 1 is a digital signal processor (DSP) which controls/outputs driving signal for the VCCD 15 and has a timing processor function of driving the VCCD 15 in N kinds of driving modes. The control section 1 generally consists of a timing pulse producing section 2 for producing timing pulses for the driving signals, and a driving signal producing section 3 for producing the driving signals based on outputs from the timing pulse producing section 2. The timing pulse producing section 2 has a setting input section 21 for receiving setting inputs such as designation of a driving mode from the outside, a timing pulse producing circuit 22 for producing timing pulses distributed with a predetermined distribution of switching periods in correspondence with an input to the setting input section 21, and a timing pulse output section 23 for outputting the timing pulses. In detail, the timing pulse producing circuit 22 produces, based on the distribution of the optimum switching periods T1:T2:T3: . . . :Tn obtained from a characteristic diagram like FIG. 1, by selecting specified timing pulses which has a distribution of switching periods corresponding a driving mode designated by an input to the setting input section 2 among the distributions of timing pulse switching periods for 1st through Nth driving modes t1¹:T2¹:T3¹: . . . :tn¹ through t1^{N}:t2^{N}:t3^{N}: . . . :Tn^{N}. The relation between the distributions of timing pulse switching periods of 1st to Nth driving modes and the distribution of the optimum switching periods is T1:T2:T3: . . . :Tn=t1¹:T2¹: t3¹: . . . :tn¹=t1^{N}:t2^{N}:t3^{N}: . . . :tn^{N}. The driving signal producing section 3 has a timing pulse input section 31 for receiving timing pulses from the timing pulse output section 23, a driving signal producing circuit 32 for producing driving signals to be supplied to the transfer gates, and a driving signal output section 33 for outputting the driving signals.

The control section 1 operates as follows. At first, a signal designating a driving mode is input to the setting input section 21 of the timing pulse producing section, and then the timing pulse producing circuit 22 makes a distribution of timing pulse switching periods in correspondence with the driving mode. For example, when a signal designating the first driving mode is input, the distribution of switching periods t1¹:t2¹:t3¹: . . . :tn¹ of the first driving mode is obtained based on the distribution of the optimum switching periods T1:T2: T3: . . . :Tn obtained from the frequency dependence of charge transfer efficiencies in FIG. 1. The relation between the distribution of switching periods of the first driving mode and the distribution of the optimum switching periods is t1¹:t2¹:t3¹: . . . :tn¹=T1:T2:T3: . . . :Tn. Timing pulses distributed with the distribution of switching periods of the first mode are output from the timing pulse output section 23 of the timing pulse producing section, and then are input to the timing pulse input section 31 of the driving signal producing section. First driving signals are made based on these timing pulses by the driving signal producing circuit 32 of the driving signal producing section, and are then output from the driving signal output section 33 to the transfer gates φV1, φV2, φV3, and φV4.

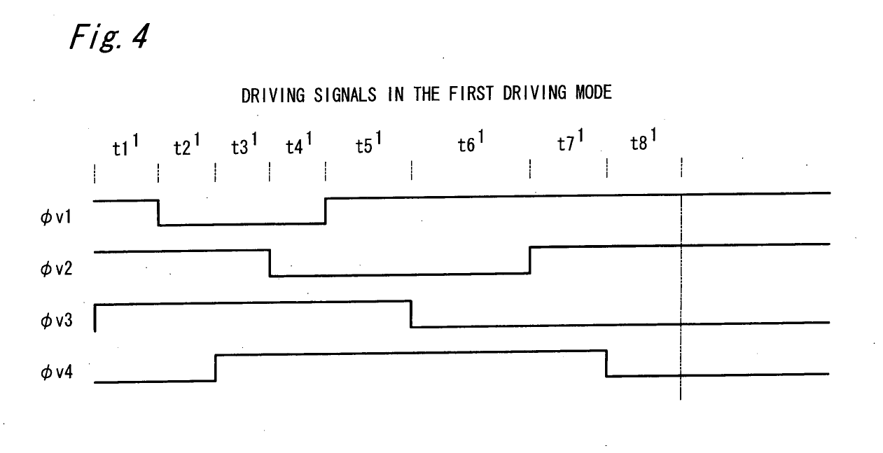

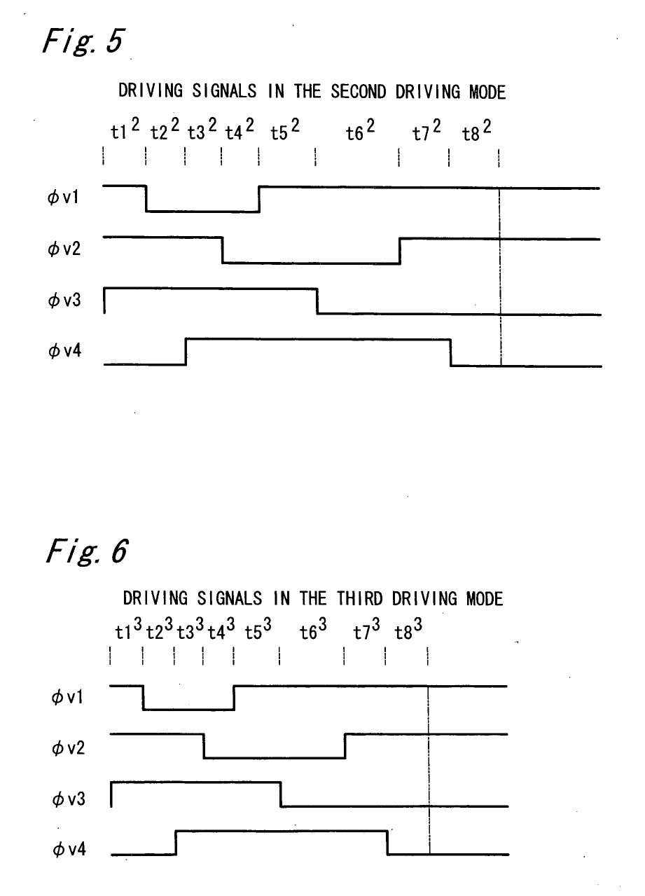

FIG. 4 shows driving signals in the first driving mode. FIG. 5 shows driving signals in the second driving mode, and FIG. 6 shows driving signals in the third driving mode. As understood from FIGS. 4 to 6, each of the driving signals are switched according to the timing pulses, and the distributions of the switching periods t1¹ to t8¹, t1² to t8², and t1³ to t8³ are obtained from the distribution of the optimum switching periods T1 to T8.

Like this, in each of the driving modes, timing pulses are produced based on the distribution of the optimum switching periods obtained from the frequency dependence of charge transfer efficiencies, and driving signals are produced according to the timing pulses. The frequency dependence of charge transfer efficiencies is obtained in consideration of the influence of the input wave rise up time constants, self-diffusion time constants, and fringe electric field drift time constants which have not be considered up to now in addition to the RC time constants of the transfer gates, so that the most effective distribution of switching periods can be obtained in consideration of the above time constants. Therefore the charge transfer efficiency of the VCCD can be effectively improved by producing driving signals using the timing pulses based on the distribution of the optimum switching periods and applying the driving signals to the transfer gates.

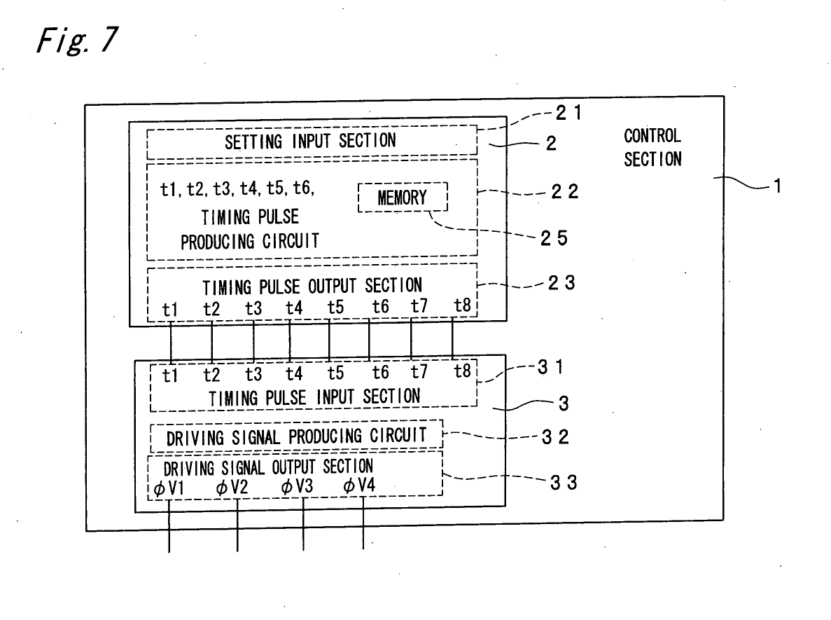

FIG. 7 is a schematic diagram showing a variation of the control section 1 of this embodiment. In FIG. 7, the same reference numbers are attached to the components having the same functions as those in FIG. 3, and the detail explanation will be omitted. The control section 1 is provided with a memory 25 which is the storage section in the timing pulse producing circuit 22 of the timing pulse producing section. The memory 25 comprises a nonvolatile semiconductor storage device. In the memory 25, information about the distributions of switching periods t1¹:T2¹:t3¹: . . . :tn¹, t1²:t2²:t3²: . . . :tn²: . . . :t1^{N}: t2^{N}:t3^{N}: . . . :tn^{N} of the 1st driving mode to Nth driving mode, and information about the distribution of the optimum switching periods T1:T2:T3: . . . :Tn obtained from the frequency dependence of charge transfer efficiencies are stored. The control section 1 reads the information about a distribution of switching periods corresponding to a predetermined driving mode from the memory 25 based on a signal which is input to the setting input section 21 of the timing pulse producing section to designate a driving mode. The timing pulse producing circuit 22 produces timing pulses based on the information which has been read, and the driving signal producing section 3 produces driving signals based on the timing pulses. Since timing pulses are produced based on the information stored in the memory 25, the timing pulse producing circuit 22 can be simplified and timing pulses can be produced speedily.

### SECOND EMBODIMENT

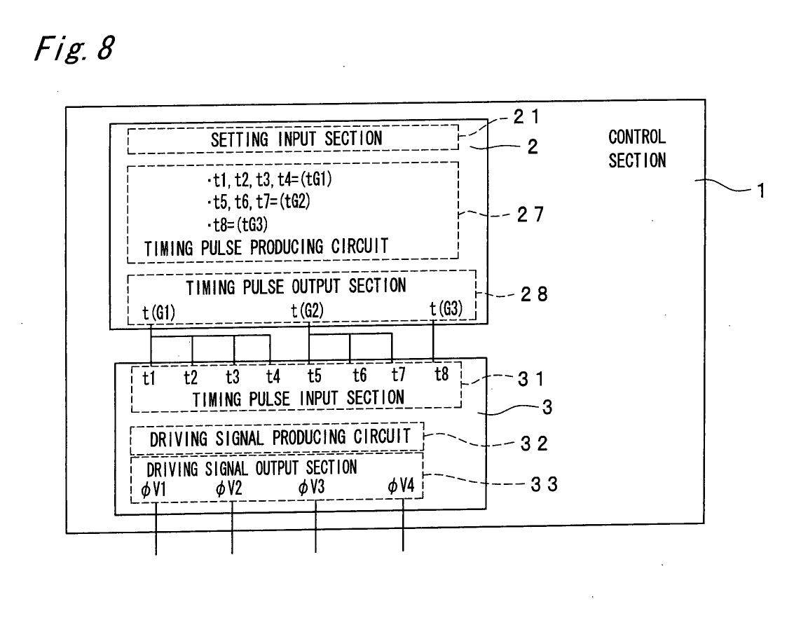

FIG. 8 is a schematic diagram showing the control section 1 provided in the solid-state image pickup device of the second embodiment of the present invention. The control section 1 is the same as for the first embodiment except for the timing pulse producing circuit 27 and timing pulse output section 28 of the timing pulse producing section. In the second embodiment, the same reference numbers are attached to the components having the same functions as those of the first embodiment, and the detail explanation will be omitted.

The timing pulse producing circuit 27 of the control section 1 of this embodiment divides all of the switching periods t1 to tn constituting one cycle of the driving of the VCCD into m groups G1 to Gm less than the number n of the switching periods, and assigns a value of switching period obtained from the frequency dependence of charge transfer efficiencies to each of the groups G1 to Gm.

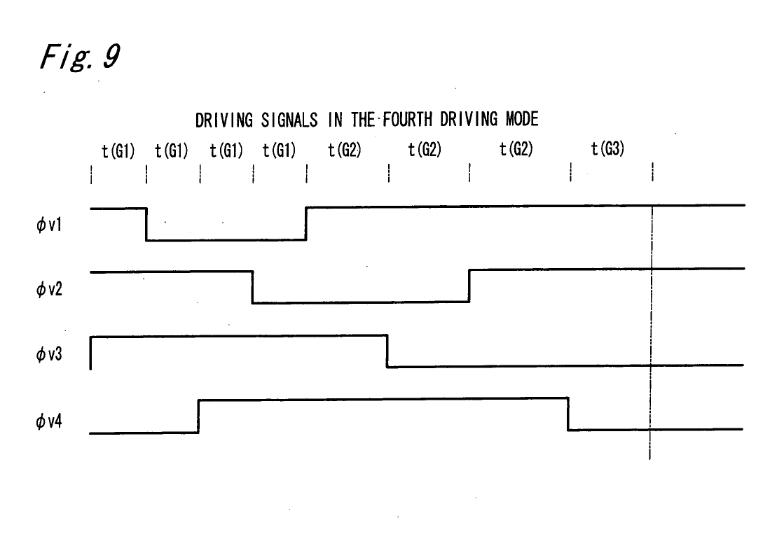

Specifically, switching periods t1 to t4 are grouped into group 1, switching periods t5 to t7 are grouped into group 2, and switching period 8 is grouped into group 3. Values of switching periods t1, t2, t3, and t4 belonging to group 1 are near to each other, and values of switching periods t5, t6, and t7 are near to each other. To groups G1, G2, and G3 among which switching periods are distributed like this, values of switching periods are assigned. The values of switching periods are obtained based on the frequency dependence of charge transfer efficiencies. That is, as switching periods representing the groups, optimum switching periods T(G1), T(G2), and T(G3) each providing a charge transfer efficiency of 90% are obtained. From the distribution of the optimum switching periods T(G1):T(G2):T(G3), the distributions of switching periods of the groups t(G1)¹:t(G2)¹:t(G3)¹, t(G1)²:t(G2)²:t(G3)², . . . , and t(G1)^{N}:t(G2)^{N}:t(G3)^{N} used in the 1st to Nth driving modes are obtained. The relation between the distribution of the optimum periods and the distributions of switching periods of 1st to Nth driving modes is T(G1):T(G2):T(G3)=t(G1)¹:t(G2)¹: t(G3)=t(G1)²:t(G2)²: . . . :t(G3)²= . . . =t(G1)^{N}:t(G2)^{N}:t(G3)^{N}. Like this, the timing pulse producing circuit 27 distributes the switching periods among groups G1, G2, and G3 to produce timing pulses according to the switching periods. FIG. 9 shows driving signals produced using the timing pulses by the driving signal producing section 3. As shown in FIG. 9, the driving signals have switching periods belonging to groups G1, G2, and G3, and the switching periods are distributed based on the frequency dependence of charge transfer efficiencies, so that the charge transfer efficiency of the VCCD can be effectively improved.

In the control section 1 of this embodiment, the configuration of the timing pulse producing section 2 can be simplified to reduce the number of registers used for the timing pulse producing section 2. That is, when the number of registers required to control n kinds of output signals from T1 to Tn in the first embodiment is Rn, the number Rm of registers required to control m kinds of output signals from T(G1) to T(Gm) having been grouped in this embodiment is given by
Rm=Rn×(m/n)
where m<n, thus Rm<Rn.

Like this, in this embodiment, since the number of registers constituting the control section 1 can be reduced, a control section 1 which has a simple circuit configuration and operates at high speed can be obtained, and thereby the configuration of the solid-state image pickup device can be simplified to increase the charge transfer rate.

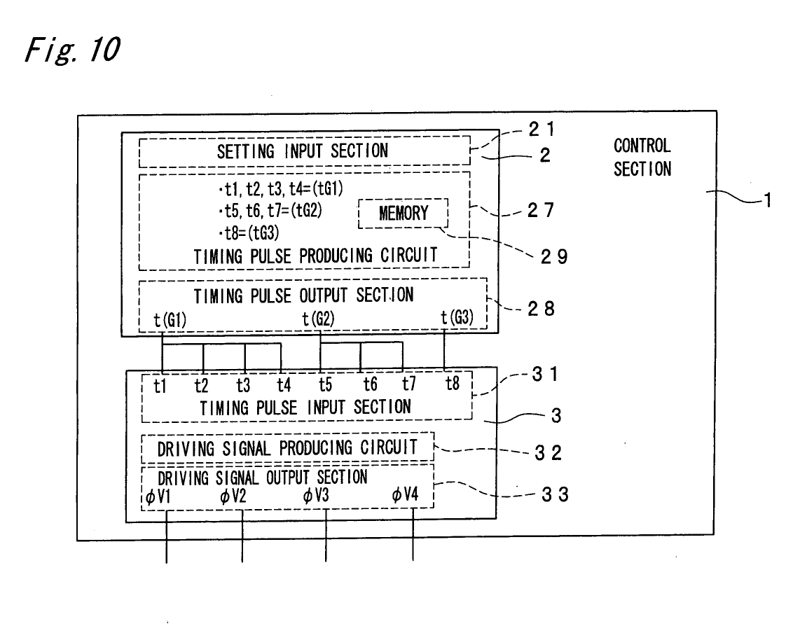

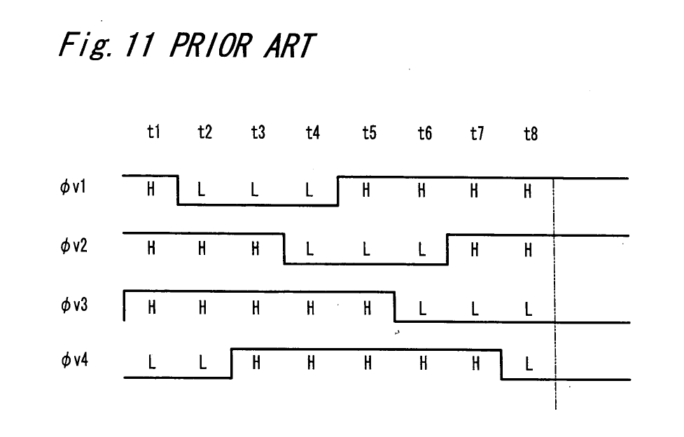

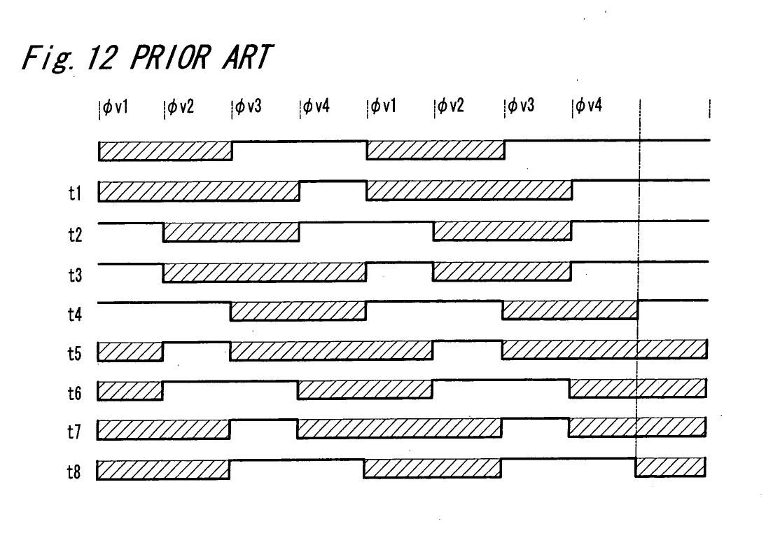

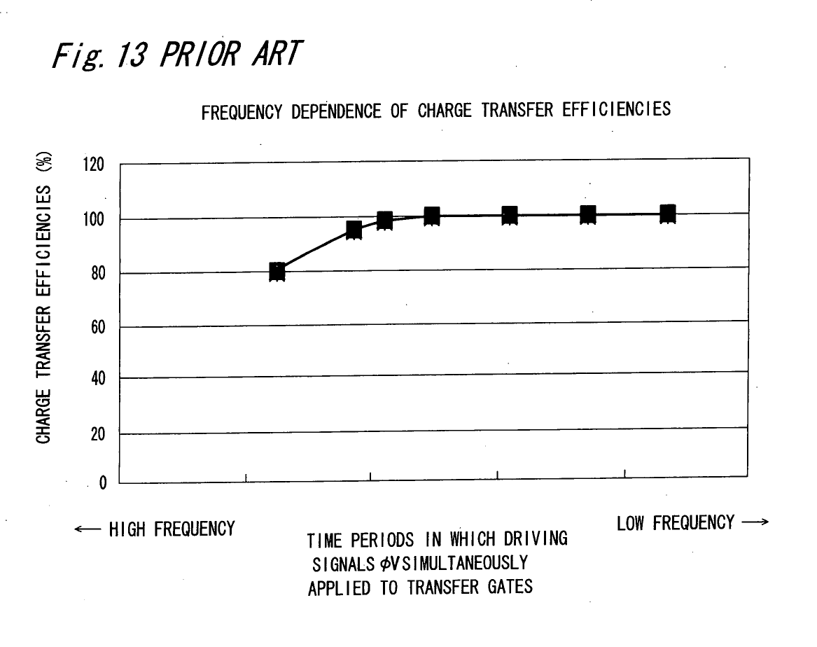

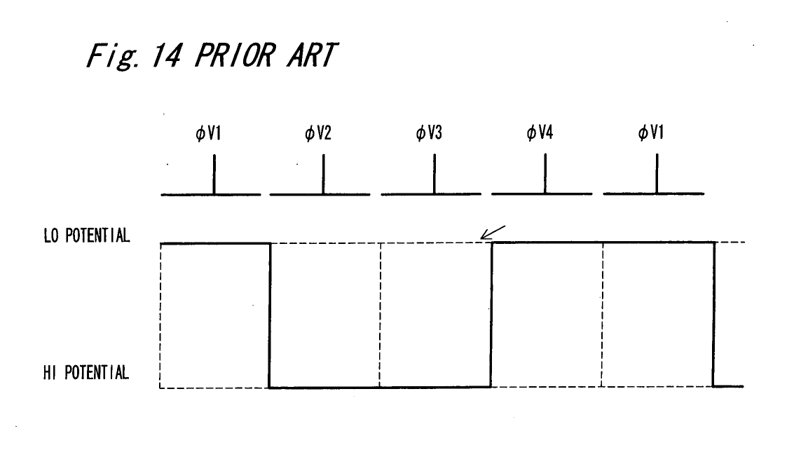

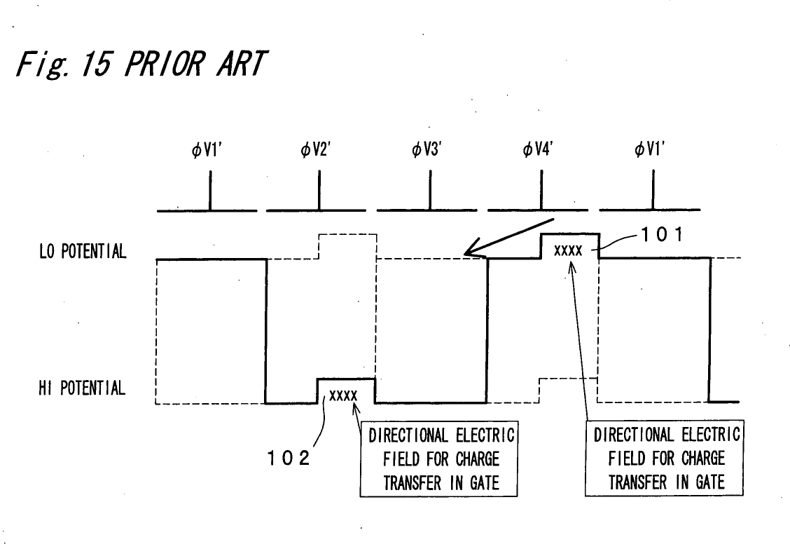

FIG. 10 is a schematic diagram showing a variation of the control section 1 of this embodiment. In FIG. 10, the same reference numbers are attached to the components having the same functions as FIG. 8, and the detail explanation will be omitted. The control section 1 is provided with a memory 29 which is the storage section in the timing pulse producing circuit 27 of the timing pulse producing section. The memory 29 comprises a nonvolatile semiconductor storage device. In the memory 29, information about the distributions of switching periods t(G1)¹:t(G2)¹:t(G3)¹, t(G1)²:t(G2)²:t(G3)², . . . , t(G1)^{N}:t(G2)^{N}:t(G3)^{N} of the groups of 1st driving mode to Nth driving mode, and information about the distribution of the optimum switching periods T(G1):T(G2):T(G3) obtained from the frequency dependence of charge transfer efficiencies are stored. The control section 1 reads the information about a distribution of switching periods corresponding to a predetermined driving mode from the memory 29 based on a signal which is input to the setting input section 21 of the timing pulse producing section to designate a driving mode. The timing pulse producing circuit 27 produces timing pulses of the groups G1, G2, and G3 based on the information which has been read, and the driving signal producing section 3 produces driving signals based on the timing pulses. Since timing pulses are produced based on the information stored in the memory 29, the timing pulse producing circuit 27 can be simplified and timing pulses can be produced speedily.

In each of the above embodiments, timing pulses are produced to output driving signals for 1st to Nth driving modes, but may be produced to output driving signals for a single driving mode.

In addition, in each of the above embodiments, a charge transfer efficiency for each switching period used as a reference when deciding the value of an optimum switching period is 90%, but a switching period corresponding to the charge transfer efficiency of 80% in FIG. 1, for example, may be used as an optimum switching period. Furthermore, a switching period corresponding to the charge transfer efficiency of 70% may be used as an optimum switching period.

Although the present invention has been described as above, it is obvious that the present invention can be modified by a variety of methods. Such modifications are not regarded as departing from the spirit and scope of the present invention, and it is appreciated that improvements apparent to those skilled in the art are fully included within the scope of the following claims.

1. A solid-state image pickup device comprising:
light-receiving pixels which are disposed in the form of a matrix and convert incident light into charges;
a vertical-transfer section which has a plurality of transfer gates for transferring charges read from the light-receiving pixels in the column direction and which transfer charges read from the light-receiving pixels in the vertical direction;
a horizontal-transfer section which is coupled with the vertical-transfer section and outputs charges transferred from the vertical-transfer section in a horizontal period cycle;
a timing pulse producing section which produces timing pulses for producing driving signals for driving the transfer gates, the timing pulse producing section producing the timing pulses in such a manner that distributions of timing pulse switching periods of driving signals for driving at least two of the transfer gates in the same column have the same distribution ratio, to each other, as the distribution of reference switching periods obtained from frequency dependence of charge transfer efficiencies such that the charge transfer efficiencies of the transfer gates are not less than a predetermined value; and
a driving signal producing section for producing driving signals for driving the transfer gates based on outputs from the timing pulse producing section.

2. A solid-state image pickup device as clamed in claim 1, wherein the timing pulse producing section produces timing pulses in such a manner that when n (natural number of 4 or more) timing pulse switching periods for producing driving signals for driving the transfer gates in a first mode are t1¹, t2¹, t3¹, . . . , and tn¹, n timing pulse switching periods for producing driving signals for driving the transfer gates in a second mode are t1², t2², t3², . . . , and tn², and n reference switching periods are T1, T2, T3, . . . , and Tn, the first mode switching periods t1¹, t2¹, t3¹, . . . , tn¹, the second mode switching periods t1², t2², t3², . . . , tn², and the reference switching periods T1, T2, T3, . . . , Tn satisfy the relation of t1¹:T2¹:t3¹: . . . :tn¹=t1²:t2²:t3²: . . . :tn²=T1:T2:T3: . . . :Tn.

3. A solid-state image pickup device as clamed in claim 1, wherein the timing pulse producing section divides n (natural number of 4 or more) timing pulse switching periods for producing driving signals for driving the transfer gates into m (natural number of 2 or more) groups less than the n switching periods, and produces timing pulses in such a manner that when timing pulse switching periods belonging to the m groups are t(G1), . . . , and t(Gm), and reference switching periods corresponding to the m groups are T(G1), . . . , and T(Gm), the switching periods t(G1), . . . , t(Gm) and the reference switching periods T(G1), T(Gm) satisfy the relation of t(G1): . . . :t(Gm)=T(G1): . . . :T(Gm).

4. A solid-state image pickup device as clamed in claim 1, wherein the timing pulse producing section divides n (natural number of 4 or more) timing pulse switching periods for producing driving signals for driving the transfer gates into m (natural number of 2 or more) groups less than the number of the switching periods, and produces timing pulses in such a manner that when timing pulse switching periods belonging to the m groups for producing driving signals for driving the transfer gates in a first mode are t(G1)¹, . . . , and t(Gm)¹, timing pulse switching periods belonging to the m groups for producing driving signals for driving the transfer gates in a second mode are t(G1)², . . . , and t(Gm)², and reference switching periods corresponding to the m groups are T(G1), . . . , and T(Gm), the first mode switching periods t(G1)¹, . . . , t(Gm)¹, the second mode switching periods t(G1)², . . . , t(Gm)², and the reference switching periods T(G1), . . . , T(Gm) satisfy the relation of t(G1)¹ t(Gm)¹=t(G1)²: . . . :t(Gm) 2=T(G1): . . . :T(Gm).

5. A solid-state image pickup device as clamed in claim 2, wherein the timing pulse producing section includes a storage section in which information about the switching periods t1¹, t2¹, t3¹, . . . , tn¹ of driving signals for driving the transfer gates in the first mode, the switching periods t1², t2², t3², . . . , tn² of driving signals for driving the transfer gates in the second mode, and the reference switching periods T1, T2, T3, . . . , Tn has been previously stored.

6. A solid-state image pickup device as clamed in claim 4, wherein the timing pulse producing section includes a storage section in which information about the switching periods t(G1)¹, . . . , t(Gm)¹ of driving signals for driving the transfer gates in the first mode, and the switching periods t(G1)², . . . , t(Gm)² of driving signals for driving the transfer gates in the second mode, which are timing pulse switching periods belonging to the m groups, and information about the reference switching periods T(G1), T(Gm) have been previously stored.

7. A driving method of a solid-state image pickup device comprising:
light-receiving pixels which are disposed in the form of a matrix and convert incident light into charges;
a vertical-transfer section which has a plurality of transfer gates for transferring charges read from the light-receiving pixels in the column direction and which transfer charges read from the light-receiving pixels in the vertical direction; and
a horizontal-transfer section which is coupled with the vertical-transfer section and outputs charges transferred from the vertical-transfer section in a horizontal period cycle, wherein
timing pulses for producing driving signals for driving the transfer gates are produced in such a manner that distributions of timing pulse switching periods of driving signals for driving at least two of the transfer gates in the same column have the same distribution ratio, to each other, as the distribution of reference switching periods obtained from frequency dependence of charge transfer efficiencies such that the charge transfer efficiencies of the transfer gates are not less than a predetermined value, and
driving signals for driving the transfer gates are produced based on the timing pulses.

8. A driving method of a solid-state image pickup device as claimed in claim 7, wherein
n (natural number of 4 or more) timing pulse switching periods for producing driving signals for driving the transfer gates are divided into m (natural number of 2 or more) groups less than the number of the switching periods, and
timing pulses are produced in such a manner that when timing pulse switching periods belonging to the m groups for producing driving signals for driving the transfer gates in a first mode are t(G1)¹, . . . , and t(Gm)¹, timing pulse switching periods belonging to the m groups for producing driving signals for driving the transfer gates in a second mode are t(G1) ², . . . , and t(Gm)², and reference switching periods corresponding to the m groups are T(G1), . . . , and T(Gm), the first mode switching periods t(G1)¹, . . . , t(Gm)¹, the second mode switching periods t(G1)²: . . . , t(Gm)², and the reference switching periods T(G1), T(Gm) satisfy the relation of t(G1)¹: . . . :T(Gm)¹=t(G1)² t(Gm)²=T(G1): . . . :T(Gm).
